(19) United States
(12) Patent Application Publication
(10) Pub. No.: US 2020/0346196 A1
(43) Pub. Date: Nov. 5, 2020

(54) CATALYSTS FOR MAKING POLYMERIC MATERIALS FROM ELEMENTAL SULFUR, AND THE METHOD OF USING THE SAME

(71) Applicant: ExxonMobil Research and Engineering Company, Annandale, NJ (US)

(72) Inventors: Huaxing Zhou, Warwick, PA (US); Victor DeFlorio, Newton, PA (US)

(21) Appl. No.: 16/848,536

(22) Filed: Apr. 14, 2020

Related U.S. Application Data
(60) Provisional application No. 62/841,439, filed on May 1, 2019.

(51) Int. Cl. B01J 31/02; C08G 75/02

(52) U.S. Cl. CPC B01J 31/0228; B01J 31/0217; C08G 75/02; B01J 31/0218

(57) ABSTRACT

The present disclosure relates to catalysts for making sulfur-containing polymeric materials. In particular, the disclosure provides catalysts, and the method of using the same, for making sulfur-containing polymeric materials through inverse vulcanization at a temperature that is lower than 150° C.

### CROSS-REFERENCE TO RELATED APPLICATIONS

This application claims the benefit of priority from U.S. Provisional Application No. 62/841,439 filed May 1, 2019, which is incorporated herein by reference in its entirety.

### FIELD OF THE INVENTION

The present disclosure relates to catalysts for making sulfur-containing polymeric materials. In particular, the disclosure provides catalysts, and the method of using the same, for making sulfur-containing polymeric materials through inverse vulcanization at a temperature that is lower than 150° C.

### BACKGROUND OF THE INVENTION

Sulfur vulcanization is a chemical process for converting natural rubber or related polymers into more durable materials by heating them with sulfur or other equivalent curatives or accelerators. Sulfur, which is not a main component, forms cross-links (bridges) between sections of polymer chain which results in increased rigidity and durability, as well as other changes in the mechanical and electronic properties of the material.

Vast amount of elemental sulfur are produced as a by-product of the hydrodesulfurization process used to reduce sulfur dioxide emissions from the combustion of fossil fuels in petroleum refining. Elemental sulfur exhibits limited solubility in the vast majority of organic solvents, with the exception of sparing solubility in aromatic media (for example, toluene), carbon disulfide and certain ionic liquids. It has long been known that under ambient conditions elemental sulfur exists primarily in the form of an eight-membered ring (S₈) that melts into a clear yellow liquid phase at 120-124° C.

Heating of the liquid sulfur phase above 159° C. results in equilibrium ring-opening polymerization (ROP) of the S₈ monomer into a linear polysulfane with diradical chain ends, which subsequently polymerizes into polymeric sulfur of high molecular weight. Polymeric sulfur generated from thermal ROP forms a semicrystalline, intractable solid with poor mechanical properties and is not amenable to melt or solution processing. Stabilization of the diradical polymeric sulfur form of this material can be achieved by quenching of the radical chain ends via copolymerization with dienes, such as dicyclopentadiene, which chemically stabilizes the polymer, but still affords a brittle crystalline material. These stabilized polymeric sulfur materials are also used for rubber vulcanization in tires, but otherwise have found limited utility.

There is a need to use these elemental sulfur by-product. It is known that elemental sulfur can be used to create stable polymers consisting mostly of sulfur via a reaction with low levels of unsaturated organic linkers (e.g. vinylic monomers). This process is called inverse vulcanization and produces polymers where sulfur is the main component. Various cross-linkers have been reported to form sustainable polymers through inverse vulcanization. Crosslinkers used include industrial feed-stocks, such as diisopropylbenzene (DIB), divinylbenzene (DVB), and dicyclopentadiene (DCPD), as well as renewable sources such as limonene, vegetable oil, myrcene, and diallyl disulfide. In general, the reactions require heating to over 160° C. to induce thiopolymerization. See, e.g., Chung et al., Nature Chemistry, vol. 5, 518-524 (2013). Unlike vulcanization, which uses sulfur to target the allylic proton for crosslinking hydrocarbon polymer chains, the inverse vulcanization uses the unsaturated organic linkers—that is not polymerized—to target sulfur chains, and the double bond in the unsaturated organic linker is consumed during the inverse vulcanization.

Avoiding higher temperatures (over 150° C.) is crucial in minimizing the formation of hydrogen sulfide, thiols, and dehydrogenation of olefins during vulcanization. Therefore, there is a need to develop a catalytic pathway that lowered the required temperature for inverse vulcanization. Lower reaction temperatures could also help avoid dangerous auto acceleration of the reactions that can occur during inverse vulcanization, and/or use cross-linkers that was otherwise prohibited from polymerization with sulfur at higher temperature by their lack of reactivity and/or low boiling point.

Suitable catalysts for inverse vulcanization have not been extensively evaluated. A recent publication discloses that metal diethyldithiocarbamate, thiram, zinc stearate and 2-cyano-2-propyl benzodithioate can be used as potential catalysts for inverse vulcanization. Wu et al., Nature Communications, vol. 10, 647 (2019). Nevertheless, alternative catalysts could further improve inverse vulcanization process, and/or to expand the class of unsaturated organic linkers for such purpose.

Therefore, there is a need in the art to develop additional catalysts for inverse vulcanization, and there is a need in the art to use catalysts to lower the inverse vulcanization temperatures and/or to achieve materials with better properties.

### SUMMARY OF THE INVENTION

The present disclosure relates to catalysts for making sulfur-containing polymeric materials. In particular, the disclosure provides catalysts, and the method of using the same, for making sulfur-containing polymeric materials through inverse vulcanization at a temperature that is lower than 150° C.

In one aspect, the present disclosure relates to catalysts for making sulfur-containing polymeric materials through inverse vulcanization. In particular, the disclosure provides a catalyst that is selected from a group consisting of tetramine, thiazole, thiophosphate, guanidine, mercaptobenzothiazole, thiourea, xanthate, and sulfenamide, or a sodium, potassium, or zinc salt thereof.

In certain embodiments, the description provides a catalyst that is selected from a group consisting of hexamethylene tetramine, 1,3-diphenylguanidine, N, N′-diorthotolyl guanidine, 2-mercaptobenzothiazole, 2,2′-dithiobis(benzothiazole), zinc-2-mercaptobenzothiazole, zinc O,O-di-n-butylphosphorodithioate, N-cyclohexyl-2-benzothiazole sulfenamide, N-tert-butyl-2-benzothiazole sulfonemide, 2-(4-morpholinothio)-benzothiazole, N,N′-dicyclohexyl-2-benzothiazole sulfenamide, ethylene thiourea, di-pentamethylene thiourea, dibutyl thiourea, zinc isopropyl xanthate, sodium isopropyl xanthate, potassium isopropyl xanthate, zinc ethyl xanthate, sodium ethyl xanthate, potassium ethyl xanthate, zinc methyl xanthate, sodium methyl xanthate, potassium methyl xanthate. In some specific embodiments, the catalyst is selected from a group consisting of 2-mercaptobenzothiazole, 2,2′-dithiobis(benzothiazole), and zinc-2-mercaptobenzothiazole.

In another aspect, the present disclosure provides methods for inverse vulcanization using the catalyst described herein. In particular, the disclosure provides methods for inverse vulcanization using the catalyst that is selected from a group consisting of tetramine, thiazole, thiophosphate, guanidine, mercaptobenzothiazole, thiourea, xanthate, and sulfenamide, or a sodium, potassium, or zinc salt thereof.

In certain embodiments, the description provides methods for inverse vulcanization using the catalyst that is selected from a group consisting of hexamethylene tetramine, 1,3-diphenylguanidine, N,N′-diorthotolyl guanidine, 2-mercaptobenzothiazole, 2,2′-dithiobis(benzothiazole), zinc-2-mercaptobenzothiazole, zinc O,O-di-n-butylphosphorodithioate, N-cyclohexyl-2-benzothiazole sulfenamide, N-tert-butyl-2-benzothiazole sulfonemide, 2-(4-morpholinothio)-benzothiazole, N,N′-dicyclohexyl-2-benzothiazole sulfenamide, ethylene thiourea, di-pentamethylene thiourea, dibutyl thiourea, zinc-isopropyl xanthate, sodium isopropyl xanthate, potassium isopropyl xanthate, zinc ethyl xanthate, sodium ethyl xanthate, potassium ethyl xanthate, zinc methyl xanthate, sodium methyl xanthate, potassium methyl xanthate. In some specific embodiments, the description provides methods for inverse vulcanization using the catalyst that is selected from a group consisting of 2-mercaptobenzothiazole, 2,2′-dithiobis(benzothiazole), and zinc-2-mercaptobenzothiazole.

In certain embodiments, the present disclosure provides methods for inverse vulcanization using the catalyst described herein, and the methods polymerizing element sulfur with ethylenically unsaturated monomers at a temperature of 100° C. to 150° C. In certain embodiments, the polymerization temperature is 120° C. to 150° C.

In certain embodiments, the present disclosure provides methods for inverse vulcanization using the catalyst described herein, and the catalyst is in the amount of 0.1 to 5 wt % of the total components in the system.

In yet another aspect, the present disclosure provides a sulfur polymer comprising one or more elemental sulfur at between about 10 to 95 wt % of the sulfur polymer; one or more ethylenically unsaturated monomers at between about 5 to 90 wt % of the sulfur polymer, and one or more catalysts disclosed herein at between about 0.1 to 5 wt % of the sulfur polymer. In certain embodiment, sulfur polymer comprising one or more elemental sulfur at between about 30 to 95 wt % of the sulfur polymer; one or more ethylenically unsaturated monomers at between about 5 to 70 wt % of the sulfur polymer, and one or more catalysts disclosed herein at between about 0.1 to 5 wt % of the sulfur polymer. In certain embodiment, sulfur polymer comprising one or more elemental sulfur at between about 40 to 95 wt % of the sulfur polymer; one or more ethylenically unsaturated monomers at between about 5 to 60 wt % of the sulfur polymer, and one or more catalysts disclosed herein at between about 0.1 to 5 wt % of the sulfur polymer. In certain embodiment, sulfur polymer comprising one or more elemental sulfur at between about 50 to 95 wt % of the sulfur polymer; one or more ethylenically unsaturated monomers at between about 5 to 50 wt % of the sulfur polymer, and one or more catalysts disclosed herein at between about 0.1 to 5 wt % of the sulfur polymer. In certain embodiment, sulfur polymer comprising one or more elemental sulfur at between about 60 to 95 wt % of the sulfur polymer; one or more ethylenically unsaturated monomers at between about 5 to 40 wt % of the sulfur polymer, and one or more catalysts disclosed herein at between about 0.1 to 5 wt % of the sulfur polymer.

Further aspects, features, and advantages of the present disclosure will be apparent to those of ordinary skill in the art upon examining and reading the following Detailed Description of the Preferred Embodiments.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating an embodiment of the invention and are not to be construed as limiting the invention. Further objects, features and advantages of the invention will become apparent from the following detailed description taken in conjunction with the accompanying figures showing illustrative embodiments of the invention, in which:

FIG. 1 illustrates sulfur-containing polymeric materials made from elemental sulfur and different organic crosslinkers: dicyclopentadiene (left) and diallyl phthalate (right).

FIG. 2 illustrates sulfur-containing polymeric materials made from elemental sulfur and dicyclopentadiene using 1,3-diiphenylguanidine as a catalyst.

FIG. 3 illustrates sulfur-containing polymeric materials made from elemental sulfur and dicyclopentadiene at different ratios.

FIG. 4 illustrates a representative Differential scanning calorimetry (“DSC”) curve to show the efficacy of catalysts. The calculated onset temperature indicates the starting temperature of the crosslinking reaction.

### DETAILED DESCRIPTION

The following is a detailed description provided to aid those skilled in the art in practicing the present disclosure. Those of ordinary skill in the art may make modifications and variations in the embodiments described herein without departing from the spirit or scope of the present disclosure. All publications, patent applications, patents, figures and other references mentioned herein are expressly incorporated by reference in their entirety.

The present description provides catalysts, and the method of using the same, for making sulfur-containing polymeric materials through inverse vulcanization at a temperature that is lower than 150° C.

Unless otherwise defined, all technical and scientific terms used herein have the same meaning as commonly understood by one of ordinary skill in the art to which this disclosure belongs. The terminology used in the description is for describing particular embodiments only and is not intended to be limiting of the disclosure.

Where a range of values is provided, it is understood that each intervening value, to the tenth of the unit of the lower limit unless the context clearly dictates otherwise (such as in the case of a group containing a number of carbon atoms in which case each carbon atom number falling within the range is provided), between the upper and lower limit of that range and any other stated or intervening value in that stated range is encompassed within the disclosure. The upper and lower limits of these smaller ranges may independently be included in the smaller ranges is also encompassed within the disclosure, subject to any specifically excluded limit in the stated range. Where the stated range includes one or both of the limits, ranges excluding either both of those included limits are also included in the disclosure.

The following terms are used to describe the present disclosure. Unless otherwise defined, all technical and scientific terms used herein have the same meaning as commonly understood by one of ordinary skill in the art to which this disclosure belongs. The terminology used in the description is for describing particular embodiments only and is not intended to be limiting of the disclosure.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of’ or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of” or “exactly one of. ”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of’ and “consisting essentially of’ shall be closed or semi-closed transitional phrases, respectively, as set forth in the United States Patent Office Manual of Patent Examining Procedures, Section 2111.03.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as anon-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, in certain methods described herein that include more than one step or act, the order of the steps or acts of the method is not necessarily limited to the order in which the steps or acts of the method are recited unless the context indicates otherwise.

As used herein in the specification and in the claims, the term “inverse vulcanization” shall be understood to be polymerizations that require mostly sulfur, based on molar amount.

As used herein in the specification and in the claims, the term “sulfur” and “element sulfur” are interchangeable, and shall be understood to be any sulfur species that yield diradical or anionic polymerizing species when heated as described herein, can be used in practicing the present invention in the broader sense of inverse vulcanization chemistry.

As used herein in the specification and in the claims, an “ethylenically unsaturated monomer” shall be understood to be a monomer that contains an ethylenically unsaturated functional group (i.e. double bond).

Non-limiting examples of ethylenically unsaturated monomers include vinyl monomers, acryl monomers, (meth)acryl monomers, unsaturated hydrocarbon monomers, and ethylenically-terminated oligomers. Examples of such monomers include, generally, mono- or polyvinylbenzenes, mono- or polyisopropenylbenzenes, mono- or polyvinyl(hetero)aromatic compounds, mono- or polyisopropenyl(hetero)-aromatic compounds, acrylates, methacrylates, alkylene di(meth)acrylates, bisphenol A di(meth)acrylates, benzyl (meth)acrylates, phenyl(meth)acrylates, heteroaryl (meth)acrylates, terpenes (e.g., squalene) and carotene. In some embodiments, non-limiting examples of ethylenically unsaturated monomers that are non-homopolymerizing include allylic monomers, isopropenyls, maleimides, norbornenes, vinyl ethers, and methacrylonitrile. In other embodiments, the ethylenically unsaturated monomers may include a (hetero)aromatic moiety such as, for example, phenyl, pyridine, triazine, pyrene, naphthalene, or a polycyclic (hetero)aromatic ring system, bearing one or more vinylic, acrylic or methacrylic substituents. Examples of such monomers include benzyl (meth)acrylates, phenyl (meth)acrylates, divinylbenzenes (e.g., 1,3-divinylbenzene, 1,4-divinylbenzene), isopropenylbenzene, styrenics (e.g., styrene, 4-methylstyrene, 4-chlorostyrene, 2,6-dichlorostyrene, 4-vinylbenzyl chloride), diisopropenylbenzenes (e.g., 1,3-diisopropenylbenzene), vinylpyridines (e.g., 2-vinylpyridine, 4-vinylpyridine), 2,4,6-tris((4-vinylbenzyl)thio)-1,3,5-triazine and divinylpyridines (e.g., 2,5-divinylpyridine). In certain embodiments, the ethylenically unsaturated monomers (e.g., including an aromatic moiety) bear an amino (i.e., primary or secondary) group, a phosphine group or a thiol group. One example of such a monomer is vinyldiphenylphosphine.

As used herein in the specification and in the claims, the term “thiazole” shall be understood to be any heterocyclic compound that contains both sulfur and nitrogen, e.g., 1,3-Thiazole, and derivatives thereof.

As used herein in the specification and in the claims, the term “thiophosphate” shall be understood to be any chemical compounds and anions with the general chemical formula PS₄₋ₓO³⁻x (x=0, 1, 2, or 3) and related derivatives where organic groups are attached to one or more O or S, e.g., zinc dialkyldithiophosphate.

As used herein in the specification and in the claims, the term “guanidine” shall be understood to be a group of organic compounds sharing a common functional group with the general structure of (R₁R₂N)(R₃R₄N)C=NR₅:

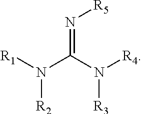

wherein R¹, R², R³, R⁴, and R⁵ are each independently hydrogen, C1-6 alkyl (linear, branched, optionally substituted by 1 or more halo, C1-6 alkoxyl), C2-6 alkenyl, C2-6 alkynyl, aryl or heteroaryl, independently substituted by 1 or more halo, hydroxyl, nitro, CN, C≡CH, or R¹, R² together with the atom they are attached to, form a 3-8 membered ring system containing 0-2 heteroatoms, or R², R³ together with the atom they are attached to, form a 4-8 membered ring system containing 0-2 heteroatoms, or R³, R⁴ together with the atom they are attached to, form a 3-8 membered ring system containing 0-2 heteroatoms, or R⁴, R⁵ together with the atom they are attached to, form a 4-8 membered ring system containing 0-2 heteroatoms. The central bond within this group is that of an imine, and the group is related structurally to amidines and ureas. Non-limiting examples of guanidines are arginine, triazabicyclodecene, saxitoxin, 1,3-diphenylguanidine, N, N′-diorthotolyl guanidine, and creatine.

As used herein in the specification and in the claims, the term “mercaptobenzothiazole” shall be understood to be a group of organic compounds sharing a common structure of:

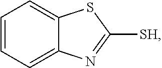

including but not limited to 2-mercaptobenzothiazole, 2,2′-dithiobis(benzothiazole) (also known as mercaptobenzothiazole disulfide), dicyclohexyl-2-benzothiazolesulfenamide, and zinc-2-mercaptobenzothiazole.

As used herein in the specification and in the claims, the term “thiourea” shall be understood to be a broad class of compounds with the general structure (R¹R²N)(R³R⁴N)C═S:

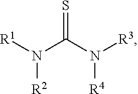

wherein R¹, R², R³, and R⁴ are each independently hydrogen, C1-6 alkyl (linear, branched, optionally substituted by 1 or more halo, C1-6 alkoxyl), C1-6 alkoxyl (linear, branched, optionally substituted by 1 or more halo), C2-6 alkenyl, C2-6 alkynyl, aryl or heteroaryl, independently substituted by 1 or more halo, hydroxyl, nitro, CN, C≡CH, or R¹, R² together with the atom they are attached to, form a 3-8 membered ring system containing 0-2 heteroatoms, or R², R⁴ together with the atom they are attached to, form a 4-8 membered ring system containing 0-2 heteroatoms, or R³, R⁴ together with the atom they are attached to, form a 3-8 membered ring system containing 0-2 heteroatoms.

As used herein in the specification and in the claims, the term “xanthate” shall be understood to be a compound, normally a salt, with the formula —OCS⁻₂M⁺, also known as O-esters of dithiocarbonate. Non-limiting examples of xanthate are zinc-isopropyl xanthate and sodium isopropyl xanthate.

As used herein in the specification and in the claims, the term “sulfenamide” shall be understood to be a class of organosulfur compounds characterized by the general formula RSNR′₂. Non-limiting examples of sulfenamide are N-cyclohexyl-2-benzothiazole sulfenamide, N-tert-butyl-2-benzothiazole sulfenamide, 2-(4-morpholinothio)-benzothiazole, and N,N′-dicyclohexyl-2-benzothiazole sulfenamide.

### Catalysts for Inverse Vulcanization and Methods Using the Same

Although polymeric sulfur is unstable and decomposes back to its monomer, it is possible to create stable polymers consisting mostly of sulfur via a reaction with low levels of unsaturated organic linkers through inverse vulcanization.

In one aspect, the present disclosure relates to catalysts for making sulfur-containing polymeric materials through inverse vulcanization at a temperature that is lower than 150° C. In particular, the disclosure provides a catalyst that is selected from a group consisting of tetramine, thiazole, thiophosphate, guanidine, mercaptobenzothiazole, thiourea, xanthate, and sulfenamide, or a sodium, potassium, or zinc salt thereof.

In certain embodiments, the description provides a catalyst that is selected from a group consisting of hexamethylene tetramine, 1,3-diphenylguanidine, N,N′-diorthotolyl guanidine, 2-mercaptobenzothiazole, 2,2′-dithiobis(benzothiazole), zinc-2-mercaptobenzothiazole, zinc O,O-di-n-butylphosphorodithioate, N-cyclohexyl-2-benzothiazole sulfenamide, N-tert-butyl-2-benzothiazole sulfonemide, 2-(4-morpholinothio)-benzothiazole, N,N′-dicyclohexyl-2-benzothiazole sulfenamide, ethylene thiourea, di-pentamethylene thiourea, dibutyl thiourea, zinc-isopropyl xanthate, sodium isopropyl xanthate, potassium isopropyl xanthate, zinc ethyl xanthate, sodium ethyl xanthate, potassium ethyl xanthate, zinc methyl xanthate, sodium methyl xanthate, potassium methyl xanthate. In some specific embodiments, the catalyst is selected from a group consisting of 2-mercaptobenzothiazole, 2,2′-dithiobis(benzothiazole), and zinc-2-mercaptobenzothiazole.

In another aspect, the present disclosure provides methods for inverse vulcanization using the catalyst described herein. In particular, the disclosure provides methods for inverse vulcanization using the catalyst that is selected from a group consisting of tetramine, thiazole, thiophosphate, guanidine, mercaptobenzothiazole, thiourea, xanthate, and sulfenamide, or a sodium, potassium, or zinc salt thereof.

In certain embodiments, the description provides methods for inverse vulcanization using the catalyst that is selected from a group consisting of hexamethylene tetramine, 1,3-diphenylguanidine, N,N′-diorthotolyl guanidine, 2-mercaptobenzothiazole, 2,2′-dithiobis(benzothiazole), zinc-2-mercaptobenzothiazole, zinc O,O-di-n-butylphosphorodithioate, N-cyclohexyl-2-benzothiazole sulfenamide, N-tert-butyl-2-benzothiazole sulfonemide, 2-(4-morpholinothio)-benzothiazole, N,N′-dicyclohexyl-2-benzothiazole sulfenamide, ethylene thiourea, di-pentamethylene thiourea, dibutyl thiourea, zinc-isopropyl xanthate, sodium isopropyl xanthate, potassium isopropyl xanthate, zinc ethyl xanthate, sodium ethyl xanthate, potassium ethyl xanthate, zinc methyl xanthate, sodium methyl xanthate, potassium methyl xanthate. Structures of these selected compounds are illustrated as follow:

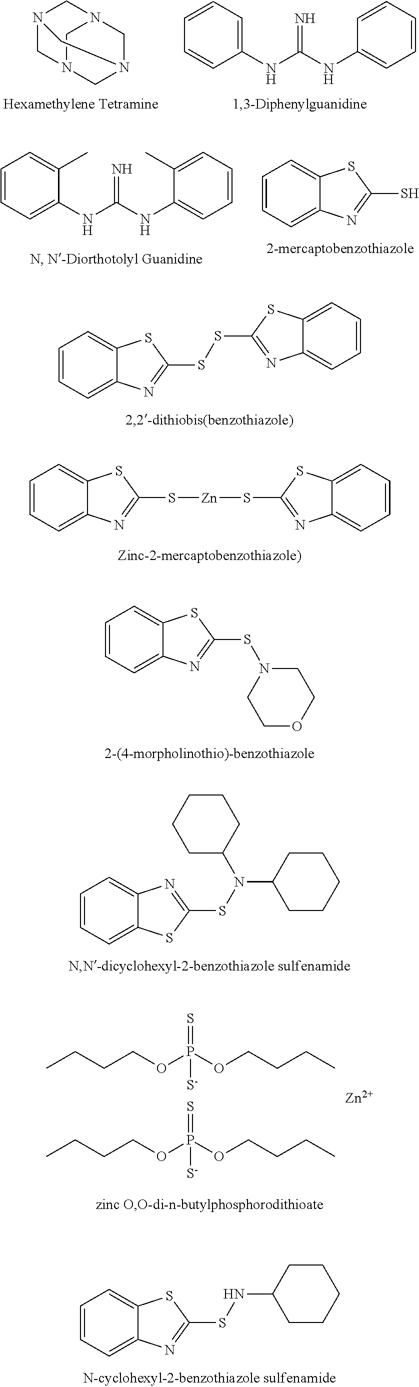

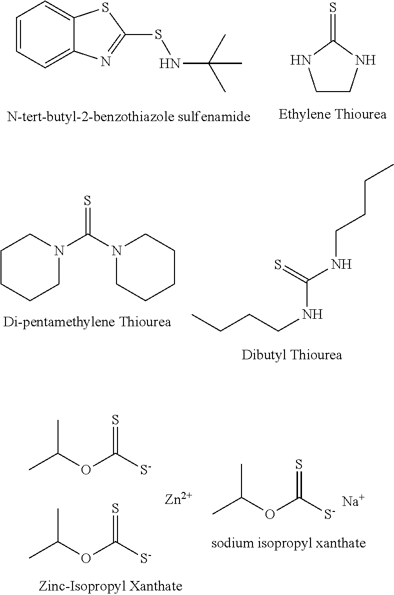

In some specific embodiments, the description provides methods for inverse vulcanization using the catalyst that is selected from a group consisting of 2-mercaptobenzothiazole, 2,2′-dithiobis(benzothiazole), and zinc-2-mercaptobenzothiazole.

In certain embodiments, the present disclosure provides methods for inverse vulcanization using the catalyst described herein, and the methods polymerizing element sulfur with ethylenically unsaturated monomers at a temperature of 100° C. to 150° C. In certain embodiments, the polymerization temperature is 120° C. to 150° C.

In certain embodiments, the present disclosure provides methods for inverse vulcanization using the catalyst described herein, and the catalyst is in the amount of 0.1 to 5 wt % of the total components in the system.

In yet another aspect, the present disclosure provides a sulfur polymer comprising higher molar ratio of elemental sulfur than molar ratio of ethylenically unsaturated monomers. In terms of weight percentage (wt %), the present disclosure provides a sulfur polymer comprising (1) one or more elemental sulfur at between about 10 wt % to about 95 wt %, about 20 wt % to about 95 wt %, about 30 wt % to about 95 wt %, about 40 wt % to about 95 wt %, about 50 wt % to about 95 wt %, about 60 wt % to about 95 wt %, about 70 wt % to about 95 wt %, about 80 wt % to about 95 wt %, about 30 wt % to about 90 wt %, about 40 wt % to about 90 wt %, about 50 wt % to about 90 wt %, about 60 wt % to about 90 wt %, about 70 wt % to about 90 wt %, about 80 wt % to about 90 wt %, about 30 wt % to about 80 wt %, about 40 wt % to about 80 wt %, about 50 wt % to about 80 wt %, about 60 wt % to about 80 wt %, about 70 wt % to about 80 wt %, about 30 wt % to about 70 wt %, about 40 wt % to about 70 wt %, about 50 wt % to about 70 wt %, about 60 wt % to about 70 wt %, or about 50 wt % to about 60 wt % of the sulfur polymer; (2) one or more ethylenically unsaturated monomers at between about 5 wt % to about 90 wt %, about 5 wt % to about 80 wt %, about 5 wt % to about 70 wt %, about 5 wt % to about 60 wt %, about 5 wt % to about 50 wt %, about 5 wt % to about 40 wt %, about 5 wt % to about 30 wt %, about 10 wt % to about 80 wt %, about 10 wt % to about 70 wt %, about 10 wt % to about 60 wt %, about 10 wt % to about 50 wt %, about 10 wt % to about 30 wt %, about 15 wt % to about 70 wt %, about 15 wt % to about 60 wt %, about 15 wt % to about 50 wt %, about 15 wt % to about 40 wt %, about 15 wt % to about 30 wt %, about 20 wt % to about 60 wt %, about 20 wt % to about 50 wt %, about 20 wt % to about 40 wt %, about 20 wt % to about 30 wt %, about 30 wt % to about 50 wt %, or about 30 wt % to about 40 wt % of the sulfur polymer; and (3) one or more catalysts disclosed herein at between about 0.1 wt % to about 5 wt %, about 0.1 wt % to about 4 wt %, about 0.1 wt % to about 3 wt %, about 0.1 wt % to about 2 wt %, or about 0.1 wt % to about 1 wt % of the sulfur polymer.

### EXAMPLES

The embodiments described above in addition to other embodiments can be further understood with reference to the following examples:

Typical experimental procedure to make sulfur polymer through inverse vulcanization:
1. Elemental sulfur, catalyst and feedstock molecules containing double bonds were placed in a 50 mL round-bottom flask with magnetic stir.
2. The reaction was heated under constant stir to a desired temperature and hold at the temperature.
3. Monitor the reaction by viscosity and an increasing viscosity is an indication for the crosslinking reaction.
4. When desired viscosity is reached, the viscous solution was then poured into a mold and transferred into an oven for further crosslinking.
5. The mold was taken out of the oven after crosslinking and cooled to room temperature.
6. The resultant product can be removed from mold for further testing and analysis.

A few examples of specific reaction conditions:

### Example 1-3: Effect of Catalyst and Amount of Ethylenically Unsaturated Monomers

1. Elemental sulfur 1 g, Zinc-2-mercaptobenzothiazole catalyst and dicyclopentadiene (Example 1: 1 g, example 2: 0.7 g, example 3: 0.5 g) were placed in a 40 mL vial with magnetic stir.
2. The reaction was heated to 125° C. under constant stir and hold at the temperature for 13 hours.
3. After reaction, the vial was cooled to room temperature and the reaction product was collected for analysis.
   The results are summarized in Table 1.

TABLE 1

| | | Catalyst | Sulfur | Dicyclo- | | Solubility |
|---|---|---|---|---|---|---|
| Sample | Catalyst | loading | (g) | pentadiene | Appearance | in toluene |
| Example 1 | No catalyst | — | 1 | 1 | Brown liquid | Yes |
| Example 2 | Zinc-2- | 1% w/w | 1 | 1 | Black solid | No |
| | mercaptobenzothiazole | | | | | |
| Example 3 | Zinc-2- | 1% w/w | 1 | 0.5 | Brown solid | Slightly |
| | mercaptobenzothiazole | | | | | |

By comparing example 1 and 2, it was observed that the catalyst is needed in order for the reaction to proceed at 125° C. And by changing the loading of dicyclopentadiene from 1 g to 0.5 g, the crosslinking become less efficient, there are some yellow elemental sulfur unreacted in the material. Therefore, there are still certain solubility in toluene.

### Example 4-6: Effect of Different Types of Ethylenically Unsaturated Monomers

1. Elemental sulfur 1 g, N-Cyclohexyl-2-benzothiazolylsulfenamide catalyst and different substrate 1 g (Example 4: divinyl benzene, example 5: diallyl phthalate, example 6: diallyl terephthalate) were placed in a 40 mL vial with magnetic stir.
2. The reaction was heated to 125° C. under constant stir and hold at the temperature for 13 hours.
3. After reaction, the vial was cooled to room temperature and the vial was cracked open and solid material was removed out of the vial.
4. The solid was then used for mechanical and solvent swelling testing. The results are summarized in Table 2.

TABLE 2

| | | Catalyst | Sulfur | Organic | | Solubility |
|---|---|---|---|---|---|---|
| Sample | Catalyst | loading | (g) | crosslinkers | Appearance | in toluene |
| Example 4 | N-Cyclohexyl-2- | 1% w/w | 1 | Divinyl benzene | Deep brown | No |
| | benzothiazolylsulfenamide | | | | solid | |
| Example 5 | N-Cyclohexyl-2- | 1% w/w | 1 | diallyl phthalate | Deep brown | No |
| | benzothiazolylsulfenamide | | | | | |
| Example 6 | N-Cyclohexyl-2- | 1% w/w | 1 | diallyl | Deep brown | No |
| | benzothiazolylsulfenamide | | | terephthalate | | |

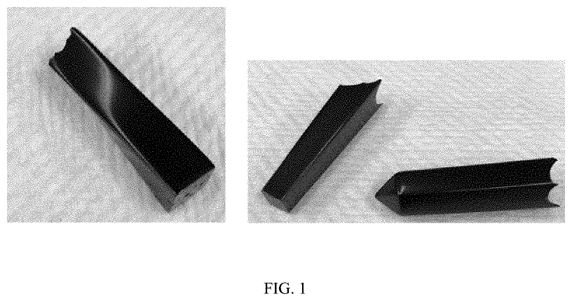

By comparing example 4-6 and example 2, the only differences between those samples are the different organic substrates used. All of these reaction proceeded successfully at 125° C. with Zinc-2-mercaptobenzothiazole catalyst. Allyl functional groups is known to be less reactive comparing vinyl. But by using the catalyst, even the diallyl system worked fine. FIG. 1 illustrates sulfur-containing polymeric materials made from elemental sulfur and different organic crosslinkers: dicyclopentadiene (left) and diallyl phthalate (right).

### Example 7-13: Effect of Different Catalyst

1. Elemental sulfur 1 g, different catalyst and dicyclopentadiene 1 g were placed in a 40 mL vial with magnetic stir.
2. The reaction was heated to 125° C. under constant stir and hold at the temperature for 13 hours.
3. After reaction, the vial was cooled to room temperature and the reaction product was collected for analysis. The results are summarized in Table 3.

TABLE 3

| | | | | | | | | Reaction |
|---|---|---|---|---|---|---|---|---|
| | | Catalyst | | Dicyclo- | | Solubility | | Onset |
| Sample | Catalyst | loading | Sulfur (g) | pentadiene (g) | Appearance | in toluene | Density | temperature (° C.) |
| Example | Na | 1% w/w | 1 | 1 | Black | No | 1.4 | 139 |
| 7 | isopropyl | | | | solid | | | |
| | xanthate | | | | | | | |
| Example | 2,2′- | 1% w/w | 1 | 1 | Black | All | — | 136 |
| 8 | Dithiobis | | | | liquid | | | |
| | (benzothiazole) | | | | (partial | | | |
| | | | | | reaction) | | | |
| Example | 1,3- | 1% w/w | 1 | 1 | Black | Slightly | 1.01 | 120 |
| 9 | Diphenyl | | | | porous | | | |
| | guanidine | | | | solid | | | |
| Example | 2- | 1% w/w | 1 | 1 | Black | Slightly | — | 115 |
| 10 | Mercapto- | | | | solid | | | |
| | benzothiazole | | | | | | | |
| Example | Zinc-2- | 1% w/w | 1 | 1 | Black | slightly | 1.7 | 117 |
| 11 | Mercapto- | | | | solid | | | |
| | benzothiazole | | | | | | | |
| Example | N- | 1% w/w | 1 | 1 | Black | No | 1.50 | 110 |
| 12 | Cyclohexyl-2- | | | | solid | | | |
| | benzothia- | | | | | | | |
| | zolylsulfenamide | | | | | | | |
| Example | Zinc o,o- | 1% w/w | 1 | 1 | Black | No | 1.39 | 148 |
| 13 | di-n- | | | | solid | | | |
| | butylphos- | | | | | | | |
| | phorodithioate | | | | | | | |
| Control | None | None | 1 | 1 | Liquid | All | — | 160 |
| example | | | | | | | | |

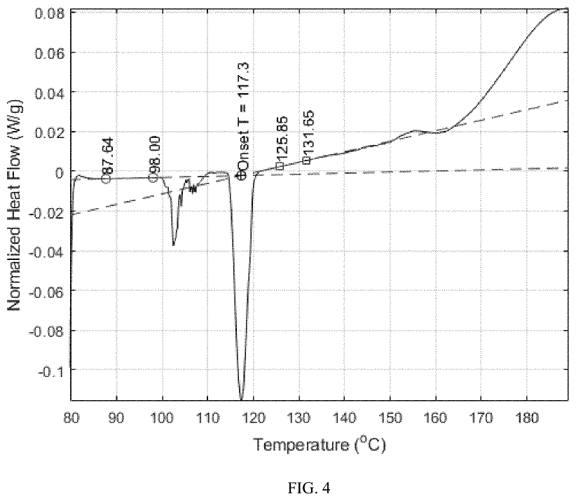

All of the catalysts shown in these examples were proving to be effective in the traditional vulcanization processes. However, for inverse vulcanization, because the reaction substrates and mechanism are different, not all of the catalysts screened here showed high efficiency at 125° C., as shown in the table above. The efficacy of catalysts at 125° C. can be determined by DSC. FIG. 4 illustrates a representative DSC curve, and the calculated onset temperature indicates the starting temperature of the crosslinking reaction. Example 7, 8 and 13 showed the reaction onset temperature higher than 125° C. But they still show some catalytic abilities by comparing with samples with no catalyst added which has an onset temperature of 160° C.

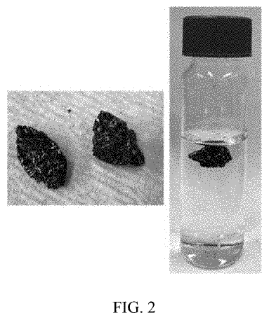

In addition, certain catalyst system showed unexpected results. In example 9, when 1,3-diiphenylguanidine was used as catalyst, the reaction was catalyzed and reaction proceeds very quickly to become a solid in 3 hrs, but instead of forming dense solid, reactions catalyzed by this type of catalysts generate porous material and much lighter in density. As shown in FIG. 2, the porous material from example 9 can float in water.

### Example 15-20: Different Loading Ratio of Sulfur vs. Dicyclopentadiene

1. Elemental sulfur, N-Cyclohexyl-2-benzothiazolylsulfenamide catalyst and dicyclopentadiene were placed in a 40 mL vial with magnetic stir.
2. The reaction was heated to 125° C. under constant stir and hold at the temperature for 13 hours.
3. After reaction, the vial was cooled to room temperature and the reaction product was collected for analysis. The results are summarized in Table 4.

TABLE 4

| | | Catalyst | Sulfur | Dicyclo- | | Solubility |
|---|---|---|---|---|---|---|
| Sample | Catalyst | loading | (g) | pentadiene (g) | Appearance | in toluene |
| Example | N-Cyclohexyl-2- | 1% w/w | 5 | 1 | Brown solid (phase | No |
| 15 | benzothiazolylsulfenamide | | | | separate) | |
| Example | N-Cyclohexyl-2- | 1% w/w | 3 | 1 | Brown solid (phase | No |
| 16 | benzothiazolylsulfenamide | | | | separate) | |
| Example | N-Cyclohexyl-2- | 1% w/w | 1 | 3 | Black solid at 22C | partial |
| 19 | benzothiazolylsulfenamide | | | | and liquid at 120C | |
| Example | N-Cyclohexyl-2- | 1% w/w | 1 | 5 | Black viscous liquid | All |
| 20 | benzothiazolylsulfenamide | | | | (partial reaction) | |

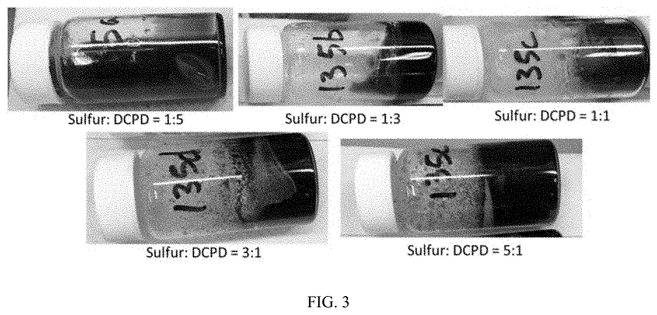

As illustrated in FIG. 3, this set of experiments showed the ratio of sulfur to organic crosslinker is important for getting high performance materials. With too much dicyclopentadiene would lead to viscous liquid and too much sulfur would lead to phase separation of excess elemental sulfur and crosslinked materials.

### Exemplary Embodiments and Pct/Ep Clauses

1. A catalyst for an inverse vulcanization is a compound selected from a group consisting of tetramine, thiazole, thiophosphate, guanidine, mercaptobenzothiazole, thiourea, xanthate, and sulfenamide, or a sodium, potassium, or zinc salt thereof, wherein the inverse vulcanization is polymerized at a temperature of 100° C. to 150° C.

2. A catalyst for an inverse vulcanization is a compound selected from a group consisting of hexamethylene tetramine, 1,3-diphenylguanidine, N,N′-diorthotolyl guanidine, 2-mercaptobenzothiazole, 2,2′-dithiobis(benzothiazole), zinc-2-mercaptobenzothiazole, zinc O,O-di-n-butylphosphorodithioate, N-cyclohexyl-2-benzothiazole sulfenamide, N-tert-butyl-2-benzothiazole sulfonemide, 2-(4-morpholinothio)-benzothiazole, N,N′-dicyclohexyl-2-benzothiazole sulfenamide, ethylene thiourea, di-pentamethylene thiourea, dibutyl thiourea, zinc-isopropyl xanthate, sodium isopropyl xanthate, potassium isopropyl xanthate, zinc ethyl xanthate, sodium ethyl xanthate, potassium ethyl xanthate, zinc methyl xanthate, sodium methyl xanthate, potassium methyl xanthate.

3. The catalyst according to clause 1, wherein the catalyst is selected from a group consisting of 2-mercaptobenzothiazole, 2,2′-dithiobis(benzothiazole), and zinc-2-mercaptobenzothiazole.

4. A method for inverse vulcanization comprising using the catalyst according to any one of the clauses 1-3.

5. The method according to clause 4 further comprising polymerizing element sulfur with ethylenically unsaturated monomers at a temperature of 100° C. to 150° C.

6. The method according to clause 4, wherein the ethylenically unsaturated monomers include vinyl monomers, acryl monomers, (meth)acryl monomers, unsaturated hydrocarbon monomers, and ethylenically-terminated oligomers.

7. The method according to clause 4, wherein the catalyst is in the amount of 0.1 to 5 wt % of the total component in the system.

8. A sulfur polymer comprising one or more elemental sulfur at between about 10 to 95 wt % of the sulfur polymer; one or more ethylenically unsaturated monomers at between about 5 to 90 wt % of the sulfur polymer, and one or more catalysts according to any one of the claims 1-3 at between about 0.1 to 5 wt % of the sulfur polymer.

9. A sulfur polymer according to clause 8, wherein one or more elemental sulfur are between about 40 to 95 wt % of the sulfur polymer; one or more ethylenically unsaturated monomers are between about 5 to 60 wt % of the sulfur polymer, and one or more catalysts are between about 0.1 to 5 wt % of the sulfur polymer.

10. A sulfur polymer according to clause 8, wherein one or more elemental sulfur are between about 50 to 95 wt % of the sulfur polymer; one or more ethylenically unsaturated monomers are between about 5 to 50 wt % of the sulfur polymer, and one or more catalysts are between about 0.1 to 5 wt % of the sulfur polymer.

11. A sulfur polymer according to clause 8, wherein one or more elemental sulfur are between about 70 to 95 wt % of the sulfur polymer; one or more ethylenically unsaturated monomers are between about 5 to 30 wt % of the sulfur polymer, and one or more catalysts are between about 0.1 to 5 wt % of the sulfur polymer.

### Equivalents

Those skilled in the art will recognize, or be able to ascertain using no more than routine experimentation, many equivalents to the specific embodiments and methods described herein. Such equivalents are intended to be encompassed by the scope of the following claims.

It is understood that the detailed examples and embodiments described herein are given by way of example for illustrative purposes only, and are in no way considered to be limiting to the disclosure. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

What is claimed is:

1. A catalyst for an inverse vulcanization is a compound selected from a group consisting of tetramine, thiazole, thiophosphate, guanidine, mercaptobenzothiazole, thiourea, xanthate, and sulfenamide, or a sodium, potassium, or zinc salt thereof, wherein the inverse vulcanization is polymerized at a temperature of 100° C. to 150° C.

2. The catalyst according to claim 1, wherein the catalyst is selected from a group consisting of hexamethylene tetramine, 1,3-diphenylguanidine, N,N′-diorthotolyl guanidine, 2-mercaptobenzothiazole, 2,2′-dithiobis(benzothiazole), zinc-2-mercaptobenzothiazole, zinc O,O-di-n-butylphosphorodithioate, N-cyclohexyl-2-benzothiazole sulfenamide, N-tert-butyl-2-benzothiazole sulfonemide, 2-(4-morpholinothio)-benzothiazole, N,N′-dicyclohexyl-2-benzothiazole sulfenamide, ethylene thiourea, di-pentamethylene thiourea, dibutyl thiourea, zinc-isopropyl xanthate, sodium isopropyl xanthate, potassium isopropyl xanthate, zinc ethyl xanthate, sodium ethyl xanthate, potassium ethyl xanthate, zinc methyl xanthate, sodium methyl xanthate, potassium methyl xanthate.

3. The catalyst according to claim 1, wherein the catalyst is selected from a group consisting of 2-mercaptobenzothiazole, 2,2′-dithiobis(benzothiazole), and zinc-2-mercaptobenzothiazole.

4. A method for inverse vulcanization comprising using the catalyst according to claim 1.

5. A method for inverse vulcanization comprising using the catalyst according to claim 2.

6. A method for inverse vulcanization comprising using the catalyst according to claim 3.

7. The method according to claim 4 further comprising polymerizing element sulfur with ethylenically unsaturated monomers at a temperature of 100° C. to 150° C.

8. The method according to claim 7, wherein the ethylenically unsaturated monomers include vinyl monomers, acryl monomers, (meth)acryl monomers, unsaturated hydrocarbon monomers, and ethylenically-terminated oligomers.

9. The method according to claim 4, wherein the catalyst is in the amount of 0.1 to 10 wt % of the total component in the system.

10. A sulfur polymer comprising:
one or more elemental sulfur at between about 10 to 95 wt % of the sulfur polymer;
one or more ethylenically unsaturated monomers at between about 5 to 90 wt % of the sulfur polymer, and
one or more catalysts according to claim 1 at between about 0.1 to 5 wt % of the sulfur polymer.

11. A sulfur polymer according to claim 10, wherein
the one or more elemental sulfur are between about 40 to 95 wt % of the sulfur polymer;
the one or more ethylenically unsaturated monomers are between about 5 to 60 wt % of the sulfur polymer, and
the one or more catalysts are between about 0.1 to 5 wt % of the sulfur polymer.

12. A sulfur polymer according to claim 10, wherein
the one or more elemental sulfur are between about 50 to 95 wt % of the sulfur polymer;
the one or more ethylenically unsaturated monomers are between about 5 to 50 wt % of the sulfur polymer, and
the one or more catalysts are between about 0.1 to 5 wt % of the sulfur polymer.

13. A sulfur polymer according to claim 10, wherein
the one or more elemental sulfur are between about 70 to 95 wt % of the sulfur polymer;
the one or more ethylenically unsaturated monomers are between about 5 to 30 wt % of the sulfur polymer, and
the one or more catalysts are between about 0.1 to 5 wt % of the sulfur polymer.
